(19) United States
(12) Patent Application Publication
(10) Pub. No.: US 2009/0235065 A1
(43) Pub. Date: Sep. 17, 2009

(54) METHOD FOR AUTOMATIC ENCRYPTION AND DECRYPTION OF ELECTRONIC COMMUNICATION

(76) Inventors: Andreas Nilsson, Stockholm (SE); Bjorn Olsson, Vastra Frolunda (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 12/280,797

(22) PCT Filed: Mar. 9, 2007
(86) PCT No.: PCT/US07/06074

§ 371 Date: Aug. 27, 2008

Related U.S. Application Data
(60) Provisional application No. 60/767,352, filed on Mar. 21, 2006.

(51) Int. Cl. H04L 29/06

(52) U.S. Cl. 713/150; 709/206; 709/224

(57) ABSTRACT

The method is for encryption and decryption of electronic communication. A monitoring module in an operating system of a first communication device is provided. A sender sends an electronic message addressed to a receiver of a second communication device. The monitoring module intercepts the message and sends a request signal to a database module. The database module monitors a secured list and sends back a positive signal when the receiver is on the list. The monitoring module sends an encryption request to an encryption/decryption module. The encryption/decryption module encrypts the message and returns an encrypted message. The encrypted message is sent as a communication signal to the second communication device.

### TECHNICAL FIELD

The method relates to a method for automatic encryption and decryption of electronic communication such as e-mail communication and instant messaging.

### BACKGROUND OF INVENTION

In view of the increased popularity of electronic communication over the Internet it has become more important to protect sensitive information that is being communicated. One problem is that currently available encryption software solutions on the market only work as add-ons, extra software on specific communication applications. There is no generic encryption solution that can easily be used by all communication applications. This means that today each application program is responsible for encrypting and decrypting its own traffic. Current encryption solutions require that both communicating parties must use the same software application add-on and that this add-on is available for every possible communication application that can be used by both parties. The software add-ons are expensive and cumbersome to use. Conventional solutions may be used to encrypt the message at the application level. The application then uses a specific application protocol, such as smtp, to format the message and pass it along to the operating system.

The operating system, at kernel level, uses a communication protocol, such as tcp/ip, to send the encrypted message. In this way, the conventional solutions focus on encrypting messages but not on the communication itself. The operating system at the receiver's end receives the communication and passes it along to the communication application at the receiving end. The add-on in the communication application on the receiver's computer then decrypts the message. The currently available encryption/decryption solutions require that both the sender and the receiver must use the same application add-on. This is expensive, cumbersome and severely restricts the use of sending encrypted messages. There is also often the case that the specific add-on used by the sender cannot be used by the recipient's communication application. There is a need for a more convenient way of sending secured communication without having to make sure that the add-on used by the sender also is available for the recipient's communication application. There is also a need for a method that automatically encrypts and decrypts sensitive parts of the electronic communication that is independent of what communication application is being used.

### SUMMARY OF INVENTION

The method of the present invention provides a solution to the above-outlined problems. More particularly, the method is for encryption and decryption of electronic communication. A monitoring module in an operating system of a first communication device is provided. A sender sends an electronic message addressed to a receiver of a second communication device. The monitoring module intercepts the message and sends a request signal to a database module. The database module monitors a secured list and sends back a positive signal when the receiver is on the list. The monitoring module sends an encryption request to an encryption/decryption module. The encryption/decryption module encrypts the sensitive parts of the communication and returns an encrypted message. What parts of the communication that is to be encrypted is decided by a specific protocol filter. The type of protocol filter used is based on what type of communication is being sent between the sender and the recipient. The encrypted message is sent as a communication signal to the second communication device.

### BRIEF DESCRIPTION OF DRAWING

FIG. 1 is a schematic view of the information flow of the system of the present invention.

### DETAILED DESCRIPTION

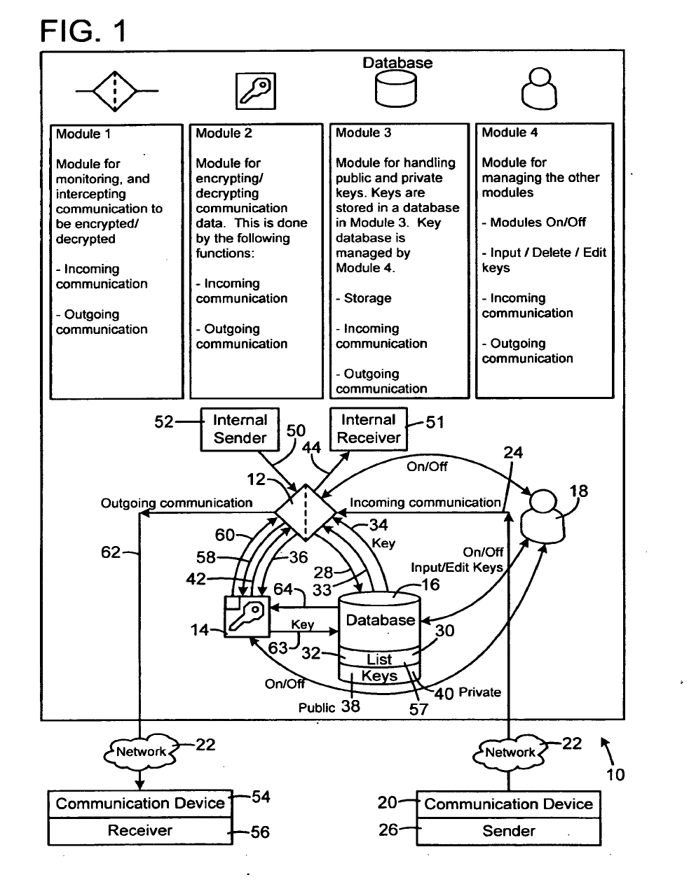

With reference to FIG. 1, the communication device 10 such as a computer system of the present invention has a monitoring module 12 that is in communication with an encryption/decryption module 14 and a database module 16. An important feature of the system 10 of the present invention is that the module 12 operates at the level of the operating system so that no additional add-on or plug-in software at the application level is required. For example, the monitoring module 12 may conduct the scanning/interception and filtering at the protocol stack of the operating system. In this way, there is no need to add software at the application level that is directly associated with an email program or any other communication software.

A managing module 18 is in communication with all the modules 12, 14 and 16. The module 18 may be used for managing the modules 12, 14 and 16 such as turning the modules, or part of the modules, on or off. The filtering functions are part of the module and these can be turned on and of independent of another. Module 18 may also be used for adding, deleting and editing keys and other settings of the modules including modifying the secured list of secured senders and recipients. In this way, the user him/herself system 10 may simply add and remove secured recipients from the secured list, as required.

The monitoring module 12 may receive an incoming electronic communication signal 24 from another communication device 20, such as a computer system, that may be in communication with the device 10 via a suitable network 22 such as the Internet. As indicated above, the monitoring module 12 monitors and intercepts all incoming and outgoing communication/traffic of the device 10. More particularly, the module 12 utilizes parts within module 14 called filters, as a filter for all incoming and outgoing communication of the computer before the communication can enter or leave the computer. The filters of the module 14 are protocol specified so that there is one filter for each protocol. These filters are interchangeable parts of the invention. Filters can easily be added or removed later on for support of other communication protocols. Because the module 12 operates at the operating system level, the module 12 is application independent. Preferably, the monitoring module 12 monitors communications including a wide range of communication protocols such as SNMP, POP, SMT, FTP, MSN, ICQ, OSCAR, TOC or any other useful communication protocols. According to the Open Standards Interconnect Model (OSI) (FIG. 2.), the communication protocols are on level 7 which is the application level that is responsible for facilitating the communication between applications such as communication between a web-server and a web browser using the http protocol or the email communication using protocols such as SMTP, POP and IMAP or instant messaging protocols such as MSN, ICQ, OSCAR, TOC. The monitoring module 12 monitors communication between layer 2 and 3 in the OSI model (see FIG. 2). By monitoring on this low level, it is possible to achieve application independence. It is also on this level, between layer 2 and 3 in the OSI model, that all communication is intercepted for encryption/decryption.

Based on the incoming message 24, the module 12 determines that the incoming message 24 is addressed to the intended receiver 51. The module 12 sends a request signal 28 to the database module 16 that has a secured list 30 that includes a list of secured recipients 57. Symmetric encryption methods, using both public keys and private keys, are used. Also, symmetric encryption methods using a pass-phrase can be used. In general, the public key is publicly known while the private key is a confidential code that is only known to the receiver of the message. In case of symmetric encryption methods being used the pass-phrase is a password known only by the recipient and the receiver. It is to be understood that any suitable encryption/decryption algorithm may be used. However, the sender and receiver should both utilize the same encryption algorithm at a given time, this is automatically taken care of by the software. The keys are provided by the database module 16 to the module 14 upon request by the module 14, as explained in more detail below. More particularly, the module 16 has a key database 70 that includes both private keys of internal or local computer users, such as the internal sender 52 and the internal receiver 51, and public keys of secured senders who are on the secured list 30. Pass-phrases may also be stored in module 14, however for safety reason this is not recommended. The module 16 may also request other public keys from key servers.

If the module 16 determines that the recipient 51 is a secured recipient 57 on the secured list 30, the module 16 sends back a positive identification signal 33. If the module 16 determines that the recipient 51 is not on the secured list 30 then the module may send back a negative identification signal 34 and the module 12 permits the message 24 to pass through without any decryption of the incoming message 24. It is also possible that the user of the system can set up the software to ask the user each time a non-secure recipient is found.

If the module 12 receives the positive identification signal 33 from the database module 16 and the message in question is encrypted, the module sends a decrypt request 36 to the module 14. The module 14 receives the decrypt request 36 and decrypts the message 24 by using a private key 40 of the internal receiver 51 or by using a pass-phrase if symmetric encryption is in use. The module 14 may first extract information about the intended receiver 51 using an appropriate filter based on the specific protocol being used and send a key request 63 to the database module 14. In response to the key request 63, the private key 40 may be provided by the database module 16 in a key signal 64.

The module 14 sends back a decrypted message 42 to the module 12 so that the decrypted message 42 may be forwarded in a communication signal 44 to the intended internal receiver 51. An important feature of the system of the present invention is that the encryption and the decryption may be taking place without the sender 26 and the receiver 51 even knowing about it. For example, the communication signal 44, as received by the internal recipient 51, may appear to be a regular email sent by the sender 26 and is received by the email program of the recipient 51.

When the monitoring module 12 intercepts an outgoing electronic communication signal 50 from an internal sender 52 so that the signal 50 is intended for another receiver 56 of an external communication device 54 that is in communication with the communication device 10 via the Internet 22. The module 12 sends the request signal 28 to the database module 16 to determine whether the receiver 56 is a secured recipient 57 on the secured list 30.

If the module 16 determines that the receiver 56 is a secured recipient 57 on the secured list 30, then the module 16 sends back the positive identification signal 33. If the module 16 determines that the receiver 56 is not on the secured list 30 then the module may send back the negative identification signal 34 or no signal at all and the module 12 permits the message 50 to pass through to the communication device 54 and its receiver 56 without any encryption of the message 50.

If the module 12 receives the positive identification signal 33 from the database module 16, the module 12 automatically sends an encrypt request 58 to the module 14. The module 14 receives the encrypt request 58 and encrypts the message 50 by using the public key 38 of the receiver 56 and the specific encryption filter for the protocol that the message is based upon. The module 14 extracts the receiver 56 from the message 50 and sends the key request 63 to the database module 16. In response to the key request 63, the public key 38 or pass-phrase of the receiver 56 may be provided by the database module 16 in the key signal 64. The filters in module 14 encrypts the parts in the message 50 that does not state the address or message type so that the encryption does not interfere with the routing and general handling of the message. The same principle applies to the decryption process. Only certain part of the message is decrypted.

The filter in module 14 sends back the encrypted message 60 to the module 12 that forwards the encrypted message 60 to a protocol stack of the operating system so that the communication device 10 can send the encrypted communication signal 62 to the communication device 54 and the receiver 56. The communication device 54 receives the encrypted communication signal 62 and goes through the same automatic decryption procedure, as described above.

In operation, the internal sender may, for example, prepare a conventional email message by using a suitable email program and press send. The email message then goes down to the operative system of the computer and to the port for outgoing messages. The monitoring module 12 intercepts the outgoing message before the message leaves the computer. Module 12 sends the request signal to the database module 28 to check if the intended recipient of the message is a secured recipient. If so, the module 12 sends an encrypt message to the filter in module 14 to encrypt the message 50. The recipient's public key or a pass-phrase is used to encrypt the message and the encrypted message 60 is sent back to module 12. The encrypted message 60 is sent out as a communication signal 62 via the communication port of the computer.

Similarly, the remote communication device 54 also has a monitoring module in the operative system that monitors all the incoming and outgoing traffic. When the encrypted communication signal 62 arrives to the remote computer, the monitoring module intercepts and determines that the receiver 56 is a secured recipient, by using its own database module, and sends a decrypt request to the encryption/decryption module of the remote computer. The decryption module uses the recipient's private key or a pass-phrase to decrypt the message before the message is sent to the application, such as email program, of the recipient 56.

One unique feature of the present invention is the ability to intercept and change without stopping a communication stream at a very low level in the computer. The change may include encryption/decryption.

The result from being able to change a communication stream at this low level, is that the encryption solution of the present invention, from a user perspective, is not dependent on a specific communication application since the solution manipulates the communication stream before it reaches the communication application. Communicating parties may use any application to communicate and the method of the present invention enables the parties/users to communicate encrypted, without the drawback of having to use the same communication applications and encrypting solutions. The end result is a dramatic freedom for the user to choose communication applications and a significant increase in interoperability between communicating parties that wish to communicate encrypted.

While the present invention has been described in accordance with preferred compositions and embodiments, it is to be understood that certain substitutions and alterations may be made thereto without departing from the spirit and scope of the following claims.

1. A method for encryption and decryption of electronic communication, comprising:
providing a monitoring module (12) in an operating system of a first communication device (10),
a sender (52) sending an electronic message (50) addressed to a receiver (56) of a second communication device (54), the second communication device (54) being in communication with the first communication device (10) via a network (22),
the monitoring module (12) automatically intercepting the message (50) prior to sending the electronic message (50) to the second communication device (54),
the monitoring module (12) sending a request signal (28) to a database module (16),
the database module (16) monitoring a secured list (30),
the database module (16) sending back a positive signal (33) when the receiver (56) is on the list (30) and a negative signal (34) when the receiver (56) is not on the list (30),
upon receipt of the negative signal (34), the monitoring module (12) sending the electronic message (50) without any encryption,
upon receipt of the positive signal (33), the monitoring module (12) sending an encryption request (36) to an encryption/decryption module (14) only when the receiver (56) is on the list (30),
upon receipt of the encryption request (36), the encryption/decryption module (14) encrypting the message (50) and returning an encrypted message (60); and
sending the encrypted message (60) as a communication signal (62) to the second communication device (54).

2. The method according to claim 1 wherein the method further comprises the monitoring module (12) automatically intercepting the outgoing message (50) without requiring any additional input from the sender (52).

3. The method according to claim 1 wherein the method further comprises the encryption/decryption module (14) using a public key or pass-phrase (40) of the receiver (56) when encrypting the message (50).

4. The method according to claim 1 wherein the method further comprises the first communication device (10) receiving an incoming signal (24) from a sender (26) intended for an internal receiver (51), the monitoring module (12) intercepting the signal (24) and sending a request signal (28) to the database signal (16), the monitoring module (12) forwarding the incoming signal (24) to the receiver (51) without decryption only when the receiver (51) is not on the secured list (30).

5. The method according to claim 4 wherein the method further comprises the monitoring module (12) receiving the positive signal (33) indicating that the receiver (51) is on the secured list (30), the module sending a decrypt request (58) to the encryption/decryption module (14).

6. The method according to claim 5 wherein the method further comprises the encryption/decryption module (14) using a private key or pass-phrase (40) to decrypt the message (24).

7. The method according to claim 6 wherein the method further comprises the monitoring module (12) automatically intercepting the message (24) before the message (24) reaches the receiver (51) without requiring any input from the receiver (51).

8. The method according to claim 7 wherein the method further comprises forwarding a message (44) including the decrypted message (24) to the receiver (51).
